(19) United States
(12) Patent Application Publication
(10) Pub. No.: US 2008/0141811 A1
(43) Pub. Date: Jun. 19, 2008

(54) Toothed Wheel For a Play-Free Gear Spur Set

(76) Inventor: Christian Sandner, Gmunden (AT)

Correspondence Address: COLLARD & ROE, P.C., 1077 NORTHERN BOULEVARD, ROSLYN, NY, 11576, US

(21) Appl. No.: 10/592,566

(22) PCT Filed: Mar. 21, 2005
(86) PCT No.: PCT/AT2005/000096

§ 371 Date: Sep. 12, 2006

(30) Foreign Application Priority Data
Mar. 22, 2004 (AT) A 495/2004

(51) Int. Cl. F16H 55/17

(52) U.S. Cl. 74/434

(57) ABSTRACT

A toothed wheel is described for a play-free spur gear set, comprising a hub (1), with a toothed ring (2) supported by the hub (1), which ring is split into two partial rings along a dividing plane normal to an axis, namely into a ring piece (3) fixed to the hub and a ring crown (4) mounted to rotate coaxially relative to the above, and an annular spring (5) enclosing the hub (1) with the circumferentially-opposed ends (6) resting on support webs (7, 8) embodied integrally with both partial rings, overlapping each other in the axial direction and arranged behind each other in the circumferential direction of the toothed ring. In order to avoid any overload of the partial rings produced by way of powder metallurgy and to ensure simple constructional conditions it is proposed that the support web (8) of one partial ring extends through the other partial ring in a through opening (9) with circumferential play and the support web (7) of the partial ring with the through opening (9) forms an assembly stop (10) defining the through opening (9) for the other support web (8).

### 1. FIELD OF THE INVENTION

The invention relates to a toothed wheel for a play-free spur gear set, comprising a hub, with a toothed ring supported by the hub, split into two partial rings along a dividing plane normal to an axis, namely into a ring piece fixed to the hub and a ring crown mounted to rotate coaxially relative to the above, and an annular spring enclosing the hub with the circumferentially-opposed ends resting on support webs embodied integrally with both partial rings, overlapping each other in the axial direction and arranged behind each other in the circumferential direction of the toothed ring.

### 2. DESCRIPTION OF THE PRIOR ART

In order to obtain a play-free gear spur set for transmitting alternating torques, the use of toothed wheels with a toothed ring split along a plane normal to an axis is known, with the two partial rings, namely a ring piece fixed to the hub and a ring crown mounted to rotate coaxially to the above, being clamped in a resilient manner against each other, so that upon engagement of such a split toothed ring into a mating gear the two partial rings will rest in a resilient manner against the mutually opposite tooth flanks of the mating gear. In order to achieve the mutual resilient clamping of the two ring pieces, an annular spring enclosing the hub is used, which spring rests with its ends for example on axial pins on the one side of the ring piece fixed to the hub and on the other side of the ring crown under a respective pretension. In order to avoid the effort required for the precisely fitting insertion of the axial pins, it has already been proposed (AT 004 880 U1) to replace said axial pins by support webs which are formed integrally with the ring piece fixed to the hub on the one hand and the ring crown on the other hand and are arranged radially mutually offset with respect to each other in order to enable them to be moved past each other in the circumferential direction. As a result of the radial shortening of the support webs and the resulting reduction of the supporting surface for the annular spring, this known construction leads to an increased pressure load of the support webs, making such constructions less suitable for sintered partial rings.

In order to avoid this disadvantage it has already been proposed (JP 11153210 A) to arrange the support webs behind one another in the circumferential direction. This known construction has the disadvantage however that the annular spring cannot be pre-tensioned during the mounting process.

It is finally known from a non-generic chain or toothed belt wheel (FR 2 805 327 A) to clamp one of two partial rings relative to the other one with the help of helical springs distributed over the circumference and effective in the circumferential direction, which springs are each inserted into a circumferential recess of the one partial ring and rest on a stop of the other partial ring projecting axially into said circumferential recess. Apart from the fact that even in the case of such a construction the pre-tensioning of the helical spring is not possible prior to a tooth engagement with a chain or toothed belt, there are conditions that are not comparable to the arrangement of helical springs distributed over the circumference.

### SUMMARY OF THE INVENTION

The invention is based on the object of providing a toothed wheel for a play-free spur gear set of the kind mentioned above in such a way that the partial rings can be produced by powder metallurgy in an integral way as sintered parts capable of withstanding all loads and which allow a simple assembly of the toothed wheel.

This object is achieved by the invention in such a way that the support web of one partial ring extends through the other partial ring in a through opening with circumferential play and the support web of the partial ring with the through opening forms an assembly stop defining the through opening for the other support web.

The support webs which are formed integrally with the associated partial rings, overlap one another in the axial direction and are arranged in the circumferential direction behind one another in order to ensure with their face sides facing the ends of the annular spring a sufficiently large supporting surface for the spring ends and to thus avoid an overload of the sintered parts require special precautions for the assembly of the annular spring between the two partial rings. For this purpose, a through opening for the web of the other partial ring is provided in one of the partial rings, the support web of which penetrates in a circumferential direction the through opening with play and finds in the support web of the partial ring having the through opening an assembly stop delimiting said through opening, so that the annular spring can be kept under a respective pre-tension with the help of the support webs mutually supporting each other in this assembly position, against which the two partial rings need to be twisted into the overlapping position of the teeth within the scope of the play of the support web penetrating the through opening in order to enable the engagement with a mating gear.

Although it is irrelevant for the function as to which of the two partial rings comprises the through opening for the support web of the respective other partial ring, especially advantageous constructional conditions can be obtained when the ring piece fixed to the hub comprises said through opening for the support web of the ring crown, because said ring piece is not subjected to any noticeable weakening as a result of its connection with the hub through the through opening.

As was already explained, the two partial rings need to be twisted against the pre-tensioning force of the annular spring in order to overlap their teeth. The assembly stop formed by the support web delimiting the through opening in the circumferential direction offers a simple constructional possibility for fixing said cover layer because it is merely necessary to insert for this purpose a spacer between the two support webs from the side of the partial ring comprising the through opening. Said spacer prevents a mutual turning back of the two partial rings into the initial position limited by the stop, so that the toothed wheel can be brought into engagement with the mating gear like a non-split toothed wheel before the spacer is removed and the teeth of the two partial rings are placed under a respective pre-tension in a resilient manner against the mutually opposing tooth flanks of the mating gear.

### BRIEF DESCRIPTION OF THE DRAWING

The subject matter of the invention is shown in the drawing by way of example, wherein:

FIG. 1 shows a toothed wheel in accordance with the invention for a play-free spur gear set in a simplified axial sectional view;

FIG. 2 shows a sectional view along line II-II of FIG. 1, and

FIG. 3 shows an illustration of the toothed wheel according to FIG. 2 in the over lapping position of the two partial rings secured by a spacer.

### DESCRIPTION OF THE PREFERRED EMBODIMENTS

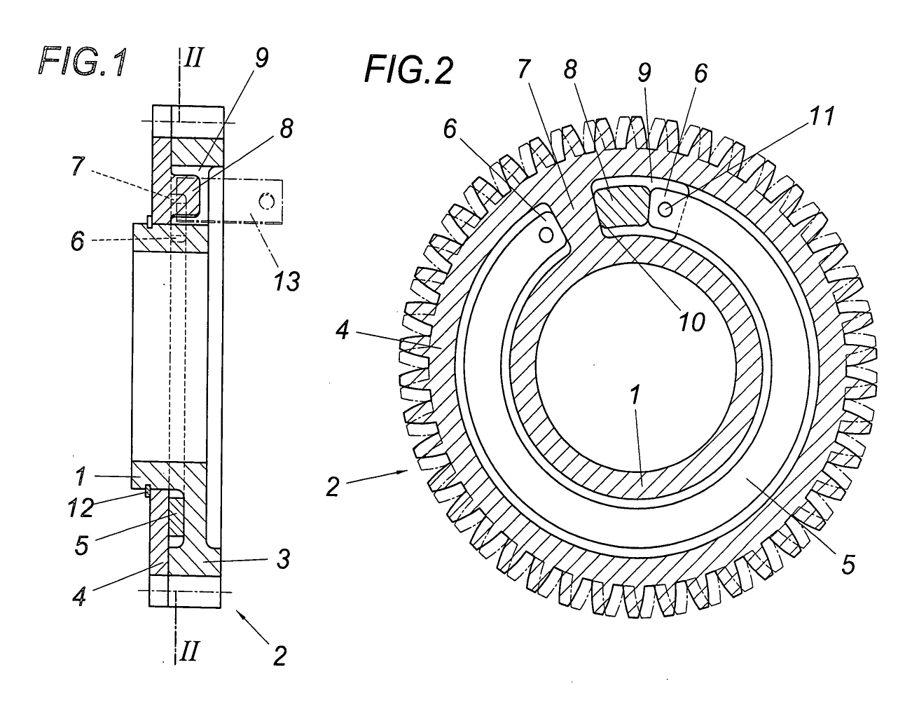

As can be seen in FIGS. 1 and 2, the illustrated toothed wheel consists of a hub 1 and a toothed ring 2 which is split along a plane perpendicular to the gear wheel axis into a ring piece 3 fixed to the hub and a ring crown 4 rotatably held on the hub 1. An annular ring 5 is provided between the ring piece 4 fixed to the hub and the ring crown 4 which is rotatable relative to the same, which annular spring encloses the hub and rests with its ends 6 opposite of each other in the circumferential direction on support webs 7 and 8 on the ring piece 3 on the one hand and the ring crown 4 on the other hand. Said support webs 7 and 8 lie behind one another in the circumferential direction of the toothed ring 2, with the support web 7 delimiting according to FIG. 2 a through opening 9 for the support web 8 of the ring crown 4 on the side averted from the associated end 6 of the annular spring 5. The arrangement is made in such a way that the support web 8 of the ring crown engages in the circumferential direction in the through opening 9 with play and, as a result of the pre-tensioning of the annular spring 5, is pressed against the support web 7 of the ring piece 3, thus forming an assembly stop 10 for the support web 8. For pre-tensioning the annular spring 5, the same is pushed at first over the hub 1 and rests on the support web 7 of the ring piece 3 fixed to the hub before it is clamped through the through opening 9 by means of a clamping tool which acts upon a catch opening 11 of the annular spring 5. By sliding the ring crown 4 on the hub 1 it is then possible to insert the support web 8 of the ring crown 4 into the through opening 9 between the support web 7 of the ring piece 3 and the end 6 of the annular spring 5 which is spread open by the clamping tool before the clamping tool is removed and the ring crown 4 is axially secured on the hub 1 by means of a coupling ring 12 for example. As a result of the pre-tensioning of the annular spring 5, the support web 8 of the ring crown 4 is pressed against the assembly stop 10 of the support web 7, with a mutual rotating position being obtained between the two partial rings of the toothed ring 2 in which the teeth of the ring crown 4 as indicated in a dot-dash way in FIG. 2 are angularly offset relative to the teeth of the ring piece 3.

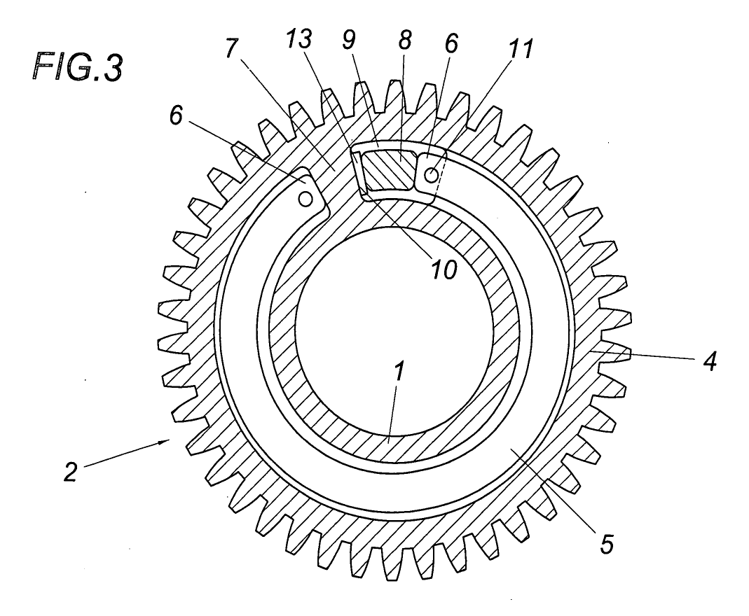

Since the toothed wheel cannot be brought into engagement with a mating gear in said angular offset, the two partial rings 3 and 4 of the toothed ring 2 must be twisted against the pre-tensioning of annular spring 5 into an overlapping position, as shown in FIG. 3. For fixing this overlapping position, a spacer 13 is used between the assembly stop 10 of the support web 7 and the support web 8. Said spacer 13 which secures the overlapping position of the partial rings 3 and 4 pre-vents the mutual turning back of the partial rings 3, 4 to the initial position according to FIG. 2, so that the toothed wheel can be brought into engagement with a mating gear without any difficulties. After the removal of the spacer 13, the pre-tension of the annular spring 5 causes a mutual twisting of the partial rings 3 and 4 until the teeth of the partial rings 3 and 4 rest in a resilient manner on the counter-flanks of the teeth of the mating gear and thus ensure a play-free tooth engagement.

With the formation of support webs 7, 8 provided in the circumferential direction behind one another, with the one support web 7 forming an assembly stop 10 for the other support web, it is possible to limit the load of the ring pieces 3 and 4 especially in the region of the support webs 7, 8 to an extent that allows the production of said partial rings 3 and 4 by way of powder metallurgy. The through opening 9 in the one partial ring 3 for the support web 8 of the other partial ring 4 ensures simple assembly conditions.

1. A toothed wheel for a play-free spur gear set, comprising a hub, with a toothed ring supported by the hub, which ring is split into two partial rings along a dividing plane normal to an axis, namely into a ring piece fixed to the hub and a ring crown mounted to rotate coaxially relative to the above, and an annular spring enclosing the hub with the circumferentially-opposed ends resting on support webs embodied integrally with both partial rings, overlapping each other in the axial direction and arranged behind each other in the circumferential direction of the toothed ring, wherein the support web (8) of one partial ring extends through the other partial ring in a thorough opening (9) with circumferential play and the support web (7) of the partial ring with the through opening (9) forms an assembly stop (10) defining the through opening (9) for the other support web (8).

2. A toothed wheel according to claim 1, wherein the ring piece (3) fixed to the hub comprises the through opening (9) for the support web (8) of the ring crown (4).

3. A toothed wheel according to claim 1, wherein a spacer (13) is insertable between the two support webs (7,8) from the side of the partial ring comprising the through opening (9).
